(19) United States
(12) Patent Application Publication
(10) Pub. No.: US 2007/0231029 A1
(43) Pub. Date: Oct. 4, 2007

(54) IMAGE FORMING APPARATUS HAVING LUBRICANT APPLICATOR FOR IMAGE CARRYING MEMBER

(76) Inventor: Yoshinori KONNO, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/696,031

(22) Filed: Apr. 3, 2007

(30) Foreign Application Priority Data
Apr. 3, 2006 (JP) 2006-102482

(51) Int. Cl. G03G 21/00

(52) U.S. Cl. 399/346

(57) ABSTRACT

An electrophotographic image forming apparatus includes an image carrying member, a lubricant, and a brush roller. The image carrying member is at least 420 mm wide. The lubricant is solid. The brush roller applies the lubricant to a surface of the image carrying member.

### CROSS-REFERENCE TO RELATED APPLICATION

This patent application is based on Japanese patent application, No. 2006-102482 filed on Apr. 3, 2006 in the Japan Patent Office, the entire contents of which are incorporated by reference herein.

### BACKGROUND OF INVENTION

1. Field of the Invention

Exemplary aspects of the present invention relate to an image forming apparatus, and more particularly to an image forming apparatus having a lubricant application mechanism for an image carrying member.

2. Description of the Related Art

A need exists for an electrophotographic image forming apparatus (such as color printers) which can produce images with high resolution and gradation qualities. In addition, a need exists to develop spherical toner having a small particle diameter to produce the image with higher image qualities.

Such small spherical toner is suitable to obtain higher image quality, but has a drawback in that it is hard to remove particles of the toner remaining on the photoconductor drum with a cleaning blade.

One example attempts to reduce the drawback by using a technique wherein a solid lubricant adhered to a rotation brush is applied to a photoconductor drum. Specifically, when the toner on the photoconductor drum is cleaned by the cleaning blade, the rotation brush contacts the solid lubricant to be applied to a surface of the photoconductor drum. The solid lubricant is used to reduce the contact resistance between the photoconductor drum and the cleaning blade, thereby improving the cleanability of the photoconductor drum.

However, when the cleaning efficiency of the cleaning blade deteriorates, the photoconductor drum cannot be cleaned appropriately and bears residual toner particles thereon. The residual toner particles can be conveyed to another image forming element, for example, a charging roller of a charging device, thereby generating charging unevenness which causes formation of an irregular image such as uneven density images and foggy images.

### SUMMARY OF THE INVENTION

According to an exemplary embodiment of the present invention, an electrophotographic image forming apparatus includes an image carrying member, a lubricant, and a brush roller. The image carrying member is at least 420 mm wide. The lubricant is solid. The brush roller applies the lubricant to a surface of the image carrying member.

### BRIEF DESCRIPTION OF THE DRAWINGS

A more complete appreciation of the exemplary embodiments of the present invention and many of the attendant advantages thereof will be readily obtained as the same becomes better understood by reference to the following detailed description when considered in connection with the accompanying drawings, wherein:

FIG. 1 is a schematic diagram partially illustrating a color image forming apparatus according to an exemplary embodiment of the present invention;

FIG. 2 is a schematic diagram illustrating a belt cleaning unit for cleaning an intermediate transfer belt and a lubricant application mechanism for use in the color image forming apparatus of FIG. 1;

FIG. 3 is a schematic diagram illustrating a photoconductor drum and another lubricant application mechanism for use in the color image forming apparatus of FIG. 1;

FIG. 4 is a schematic side view illustrating a solid lubricant divided into two parts and arranged in a zigzag in a longitudinal direction;

FIG. 5 is another schematic side view illustrating a solid lubricant divided into three parts and arranged in a zigzag in a longitudinal direction;

FIG. 6 is a schematic perspective view illustrating an example solid lubricant used in the color image forming apparatus of FIG. 1;

FIG. 7 is a schematic perspective view illustrating a combination of a lubricant holding member and the solid lubricant of FIG. 6;

FIG. 8 is a cross section illustrating a ground member having loop-shaped strings for use in a lubricant application roller of the lubricant application mechanism;

FIG. 9 is a cross section illustrating a ground member having non-loop-shaped strings for use in the lubricant application roller of the lubricant application mechanism;

FIG. 10 is a cross section illustrating the solid lubricants arranged with a gap therebetween; and

FIGS. 11A, 11B, and 11C are perspective views illustrating abrasion of the solid lubricant with the lubricant holding member.

### DETAILED DESCRIPTION OF EXEMPLARY EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, a color image forming apparatus according to an exemplary embodiment of the present invention is described.

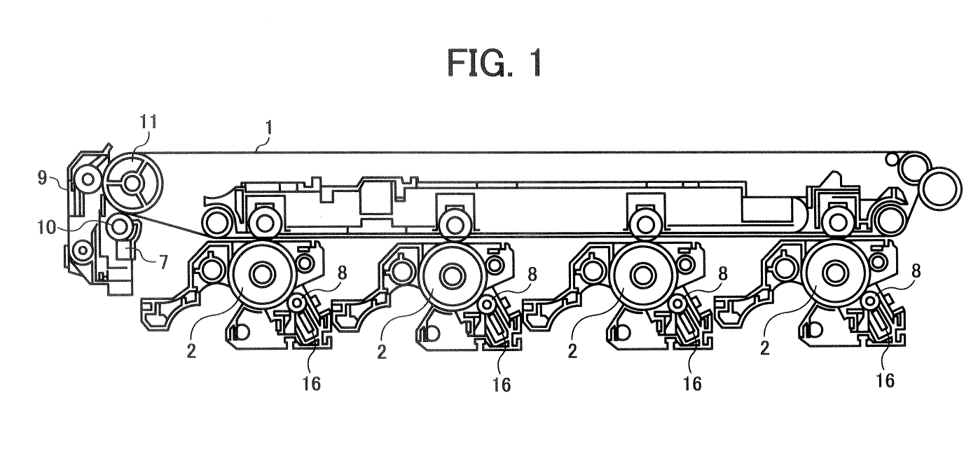

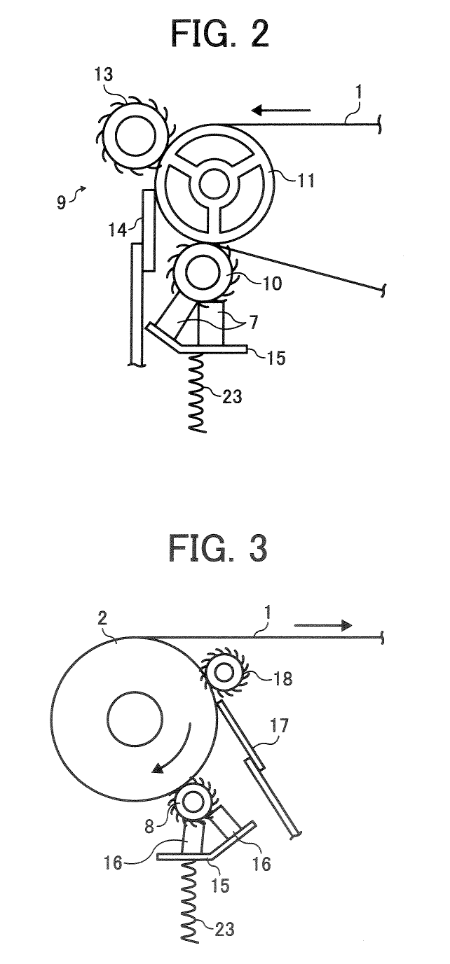

Referring to FIG. 1, the color image forming apparatus is partially illustrated with four image forming units. The image forming apparatus includes an intermediate transfer belt 1, an intermediate transfer roller 11, a belt cleaning unit 9, a belt lubricant brush roller 10, a belt lubricant 7, photoconductor drums 2, drum lubricants 16, and drum lubricant brush rollers 8. The belt lubricant brush roller 10 and the belt lubricant 7 are portions of a first lubricant application mechanism described in FIG. 2. The drum lubricants 16 and the drum lubricant brush rollers 8 are portions of a second lubricant application mechanism described in FIG. 3.

The intermediate transfer belt 1 is an intermediate transfer member on which a toner image is transferred. The intermediate transfer roller 11 rotates the intermediate transfer belt 1. The belt cleaning unit 9 cleans the intermediate transfer belt 1. The belt lubricant brush roller 10 applies a lubricant to the intermediate transfer belt 1. The belt lubricant 7 is a solid lubricant applied to the intermediate transfer belt 1 through the belt lubricant brush roller 10. The photoconductor drums 2 form electrostatic latent images thereon by being exposed to laser beams (not shown). The drum lubricants 16 are solid lubricants applied to the photoconductor drums 2 through the drum lubricant brush rollers 8. The drum lubricant brush rollers 8 apply the drum lubricants 16 to the photoconductor drums 2. The color image forming apparatus includes the four image forming units to form four color images. Each of the four image forming units includes the photoconductor drum 2, drum lubricant 16, and drum lubricant brush roller 8, and is configured to be similar to one another except for the toner color.

Referring to FIG. 2, the first lubricant application mechanism and the belt cleaning unit 9 of FIG. 1 are illustrated. The belt cleaning unit 9 includes an intermediate transfer brush roller 13 and an intermediate transfer cleaning blade 14. The first lubricant application mechanism includes the belt lubricant brush roller 10, the belt lubricant 7, a lubricant holding member 15, and a spring 23.

The intermediate transfer belt 1 is rotated in a direction, indicated by an arrow shown in FIG. 2. In one exemplary embodiment, the intermediate transfer belt 1 is at least 420 mm wide. When the toner image on the intermediate transfer belt 1 is transferred onto a recording sheet, the intermediate transfer brush roller 13 acts as a sub-cleaning mechanism and cleans remaining toner from a surface of the intermediate transfer belt 1 in an initial cleaning process. The intermediate transfer cleaning blade 14 acts as a main cleaning mechanism and further cleans the surface of the intermediate transfer belt 1. By using the two cleaning mechanisms, the surface of the intermediate transfer belt 1 can maintain its cleanliness, and an image transfer process can be repeated.

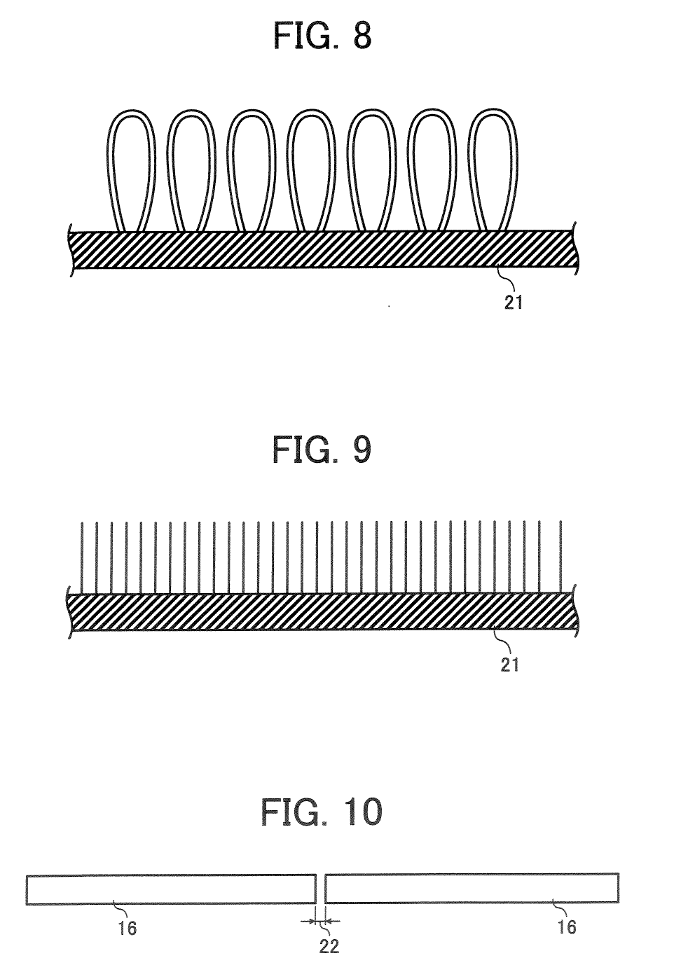

When the intermediate transfer belt 1 is cleaned for a next image transfer process, the belt lubricant 7 is applied to the intermediate transfer belt 1 by the belt lubricant brush roller 10. As shown in FIG. 2, the belt lubricant brush roller 10 is rotated while contacting the intermediate transfer belt 1 and the belt lubricant 7. Therefore, the belt lubricant 7 is applied to the intermediate transfer belt 1. The belt lubricant brush roller 10 includes a ground member 21 wound around a shaft thereof. The description of the ground member 21 will be given in the discussion of FIG. 8 and FIG. 9.

Referring to FIG. 3, the second lubricant application mechanism and the photoconductor drum 2 of FIG. 1 are enlarged. In one exemplary embodiment, the photoconductor drum 2 is at least 420 mm wide. As the color image forming apparatus of the exemplary embodiment shown in FIG. 1 includes the four image forming units, the lubricant application mechanism and the photoconductor drum 2 of FIG. 3 are representative of the four lubricant application mechanisms and the four photoconductor drums 2 of FIG. 1. The lubricant application mechanism of FIG. 3 is similar to that of FIG. 2, except for the drum lubricant brush roller 8 and the drum lubricant 16.

The photoconductor drum 2 and the intermediate transfer belt 1 are rotated in directions, indicated by respective arrows shown in FIG. 3. The electrostatic latent image on the photoconductor drum 2 is developed with a toner, and the toner image on the photoconductor drum 2 is transferred onto the intermediate transfer belt 1. When the toner image is transferred onto the intermediate transfer belt 1, a photoconductor brush roller 18 acts as a sub-cleaning mechanism and cleans remaining toner from a surface of the photoconductor drum 2. A photoconductor cleaning blade 17 acts as a main cleaning mechanism and further cleans the surface of the photoconductor drum 2. Therefore, the remaining toner on the photoconductor drum 2 is removed, and the surface of the photoconductor drum 2 can maintain its cleanliness.

As shown in FIG. 3, the drum lubricant brush roller 8 is rotated while contacting the photoconductor drum 2 and the drum lubricant 16. Therefore, the drum lubricant 16 is applied to the photoconductor drum 2 by the drum lubricant brush roller 8. The drum lubricant brush roller 8 is similar to the belt lubricant brush roller 10, and includes the ground member 21 which will be described with respect to FIG. 8 and FIG. 9.

The color image forming apparatus of the exemplary embodiment can include a plurality of small solid lubricants such as the drum lubricants 16 instead of a long solid lubricant. For example, the long solid lubricant is divided into a plurality of small solid lubricants. The length in a longitudinal direction of each small solid lubricant is shorter than that of the long lubricant. A related art image forming apparatus capable of dealing with A3 (297 mm×420 mm) or smaller sized sheets includes a long solid lubricant having a length of 300 mm. Another related art image forming apparatus capable of dealing with A2 (420 mm×594 mm) or larger sized sheets includes a long solid lubricant having a length of 500 mm. Such long solid lubricants are harder to handle or are more costly compared to the small solid lubricant used in the exemplary embodiment.

Each of the long solid lubricants can suffer damage during transportation. However, when the long solid lubricant is divided into the plurality of small solid lubricants, it is easier to handle during transportation and installation, for example. Each of the small solid lubricants can be applied to mass-produced image forming apparatuses when a common part is used. Therefore, by using the plurality of small solid lubricants, the manufacturing cost can be reduced while the technology used in the related art image forming apparatuses (such as technologies for preventing damage of the lubricant during the transportation) can be applied to the color image forming apparatus.

The color image forming apparatus of the exemplary embodiment uses zinc stearate for the solid drum lubricant 16. However, the solid drum lubricant 16 can include relatively higher fatty acids, for example, barium stearate, lead stearate, nickel stearate, cobalt stearate, iron stearate, copper stearate, strontium stearate, calcium stearate, cadmium stearate, magnesium stearate, manganese oleate, iron oleate, cobalt oleate, lead oleate, magnesium oleate, copper oleate, lead palmitate, cobalt palmitate, copper palmitate, magnesium palmitate, aluminum palmitate, calcium palmitate, lead caprylate, lead caproate, lead linolate, cobalt linolate and cadmium linolate. The solid drum lubricant 16 may include a colloidal high-temperature silica powder and a natural wax such as carnauba waxes. The solid drum lubricant 16 may include one of the above materials and a combination thereof (two or more materials). The above materials and conditions can be applied to the belt lubricant 7.

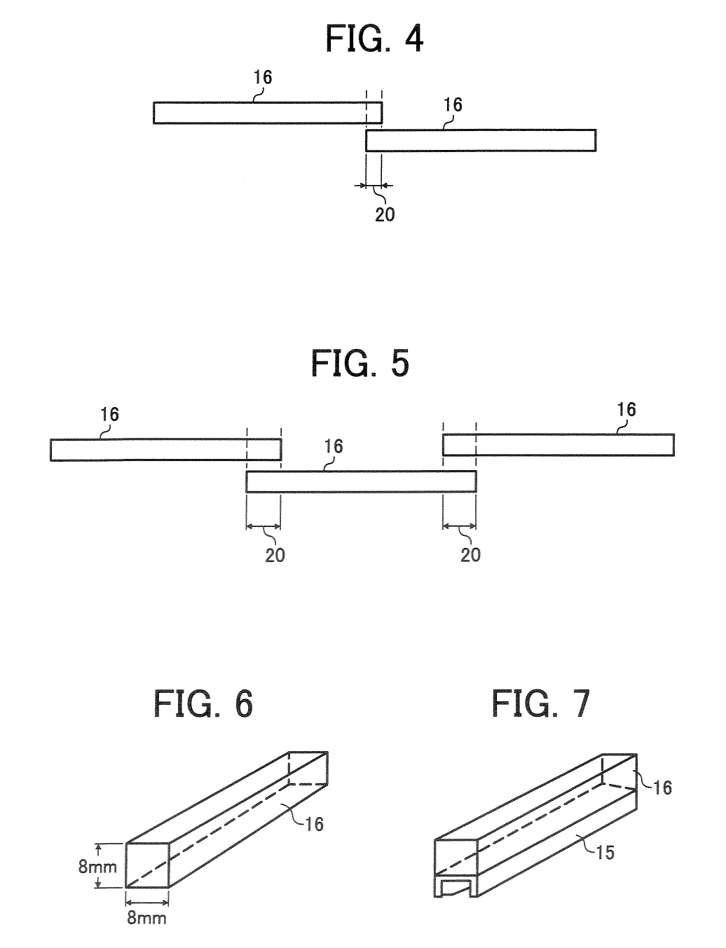

FIG. 4 illustrates an example situation in which two drum lubricants 16 are positioned in a longitudinal direction.

FIG. 5 illustrates another example situation in which three drum lubricants 16 are positioned in a longitudinal direction.

As shown in FIG. 4 and FIG. 5, the drum lubricants 16 are disposed in a zigzag in the longitudinal direction to reduce a gap which will be described with respect to FIG. 10. An overlap area 20 is an area in which the drum lubricants 16 overlap each other. For example, at least one of the drum lubricants 16 is shifted in the zigzag by an amount that is a size of a thickness thereof so as to form the overlap area 20. The configuration of the drum lubricants 16 of FIG. 4 and FIG. 5 may be applied to the belt lubricants 7 shown, for example, in FIG. 2.

Referring to FIG. 6, the drum lubricant 16 used in the color image forming apparatus of the exemplary embodiment is illustrated. The drum lubricant 16 including zinc stearate is sized 8 mm×8 mm. The drum lubricant 16 of FIG. 6 may be applied to the belt lubricant 7.

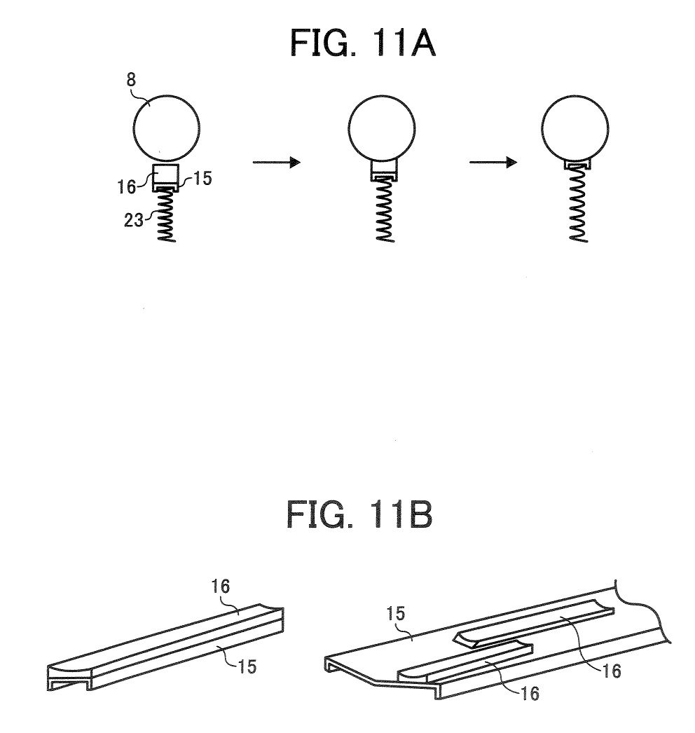

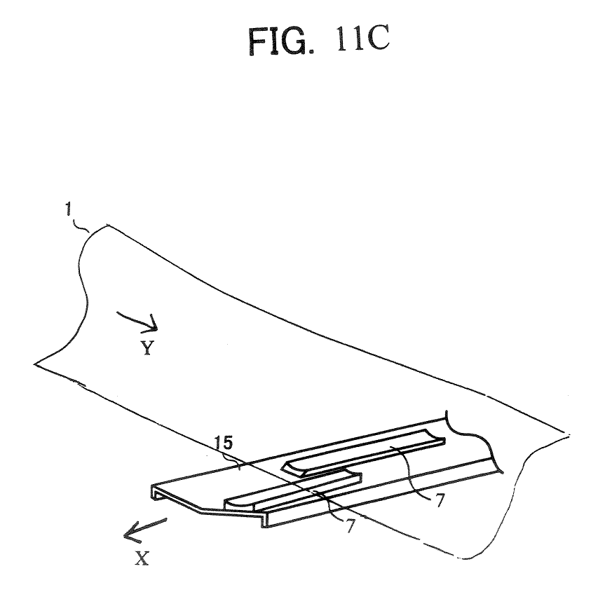

Referring to FIG. 7, the drum lubricant 16 with a lubricant holding member 15 is illustrated. The lubricant holding member 15 holds a surface of the drum lubricant 16 to hold the drum lubricant 16 so that the drum lubricant 16 is used efficiently. The description of the lubricant holding member 15 will be given with respect to FIG. 11. The configuration of the drum lubricant 16 of FIG. 7 may be applied to the belt lubricant 7.

Referring to FIG. 8, an example of the ground member 21 of the belt lubricant brush roller 10 is illustrated in a cross section. The ground member 21 is a fabric wound around the shaft of the belt lubricant brush roller 10, and includes a plurality of twisted loop-shaped strings woven thereinto.

Referring to FIG. 9, another example of the ground member 21 is illustrated in a cross section. The ground member 21 of FIG. 9 is similar to that of FIG. 8, except for the shape of its strings. The ground member 21 may include a plurality of non-loop-shaped strings woven thereinto. The ground member 21 of FIG. 8 and FIG. 9 can be applied to the drum lubricant brush roller 8.

FIG. 10 illustrates an exemplary embodiment in which the two drum lubricants 16 disposed in a straight line include a gap 22 therebetween. When the long solid lubricant is divided into a plurality of small solid lubricants, for example, two, and disposed in a straight line, the two small solid lubricants may have the gap 22 therebetween.

Since the gap 22 is generated between the drum lubricants 16, at least one of the lubricants 16 may not be applied to an area (referred to as a non-lubricated area). However, when the drum lubricants 16 are disposed in the zigzag and include the overlap area 20 therebetween as shown in FIG. 4 and FIG. 5, the color image forming apparatus can reduce an occurrence of having the non-lubricated area. The color image forming apparatus can include four or more drum lubricants 16 that are disposed in the zigzag with the overlap gaps 20. The color image forming apparatus may include four or more belt lubricants 7 that are disposed in the zigzag with the overlap gaps 20.

Referring to FIGS. 11A and 11B, abrasion of the drum lubricant 16 with the lubricant holding member 15 is illustrated. The drum lubricant 16, with one surface thereof held by the lubricant holding member 15, is gradually abraded by the drum lubricant brush roller 8 as illustrated in FIG. 11A. The surface of the drum lubricant 16 is abraded along the drum lubricant brush roller 8 so that the drum lubricant 16 is used efficiently. The abraded drum lubricant 16 with the lubricant holding member 15 is illustrated in FIG. 11B. The lubricant holding member 15 may include metal and resin. In the color image forming apparatus of the exemplary embodiment, the lubricant holding member 15 preferably includes a rigid material so that a strength of the drum lubricant 16 is increased. The drum lubricant 16 and the lubricant holding member 15 can be fixed by a double-sided adhesive tape

As shown in FIG. 11A, the lubricant holding member 15 is pressed from a backside thereof by a pressure holding mechanism, for example, the spring 23 so as to be fixed by pressure. When the drum lubricant 16 is abraded, the pressure holding mechanism can apply appropriate pressure. Therefore, the drum lubricant 16 can be pressed against the drum lubricant brush roller 8, and can be used efficiently. The configuration of the drum lubricant 16 in FIG. 11A and FIG. 11B may be applied to the belt lubricant 7, as shown in FIG. 11C.

FIG. 11C shows the lubricant holding member 15 and the belt lubricant 7, along with a portion of the intermediate transfer belt 1. Pieces of the belt lubricant 7 are arranged in a direction (represented by arrow X) that is perpendicular to a rotation direction (represented by arrow Y) of the intermediate transfer belt 1. Additionally, a portion of the pieces of the belt lubricant 7 have an overlap area in a direction perpendicular to the rotation direction of the intermediate transfer belt 1.

The zinc stearate drum lubricant 16 of the color image forming apparatus of the exemplary embodiment may be applied to an image forming apparatus having a process cartridge that includes an attachment portion to attach a lubricant for an image carrying member. Such a process cartridge includes a charging device, an optical writing device, a development device, a primary transfer roller, the drum lubricant brush roller 8, a cleaning device and a discharge device disposed in a vicinity of the photoconductor drum 2. The process cartridge is configured to include at least the drum lubricant 16, the lubricant holding member 15 and the drum lubricant brush roller 8. Therefore, the charging device uniformly charges the surface of the photoconductor drum 2 so that the surface of the photoconductor drum 2 forms the electrostatic latent image thereon by the laser beam. The development device develops the electrostatic latent image on the photoconductor drum 2 with the toner to form a toner image. Then, the toner image is transferred onto a recording sheet by a transfer device, for example, an intermediate transfer unit.

Numerous additional modifications and variations are possible in light of the above teachings. It is therefore to be understood that within the scope of the appended claims, the disclosure of this patent specification may be practiced otherwise than as specifically described herein.

What is claimed is:

1. An electrophotographic image forming apparatus, comprising:
an image carrying member that is at least 420 mm wide;
a lubricant that is solid;
a brush roller configured to apply the lubricant to a surface of the image carrying member.

2. The image forming apparatus of claim 1, wherein the lubricant includes a plurality of pieces disposed in a direction perpendicular to a rotation direction of the image carrying member.

3. The image forming apparatus of claim 2, wherein the plurality of pieces of the lubricant are disposed so as to have an overlap area in a direction perpendicular to the rotation direction of the image carrying member.

4. The image forming apparatus of claim 3, wherein the overlap area is arranged in a zigzag pattern in a direction perpendicular to the rotation direction of the image carrying member.

5. The image forming apparatus of claim 2, wherein each of the pieces of the lubricant includes a lubricant holding member attached to a surface thereof in a direction perpendicular to the rotation direction of the image carrying member.

6. The image forming apparatus of claim 5, further comprising:
an elastic mechanism configured to press the lubricant holding member towards the brush roller.

7. A process cartridge comprising:
an image carrying member that is at least 420 mm wide; and
a lubricant that is solid;
wherein the process cartridge is detachably attached to the image forming apparatus of claim 1 as a unit.

8. The image forming apparatus of claim 1, wherein the brush roller includes a ground member attached to a shaft of the brush roller, the ground member including a plurality of twisted loop-shaped strings attached thereto.

9. The image forming apparatus of claim 1, wherein the brush roller includes a ground member attached to a shaft of the brush roller, the ground member including a plurality of non-loop-shaped strings attached thereto.

10. An image forming apparatus, comprising:
an image carrying member;
a first brush roller configured to clean the image carrying member;
a cleaning blade located downstream from the first brush roller in an image transfer direction, the cleaning blade configured to clean the image carrying member;
a second brush roller located downstream from the cleaning blade in the image transfer direction, the second brush roller configured to apply a solid lubricant to a surface of the image carrying member.

11. An image forming apparatus, comprising:
an image transfer member that is at least 420 mm wide;
an image drum member that is at least 420 mm wide;
a lubricant that is solid, the lubricant including a plurality of pieces;
a first brush roller configured to apply at least two of the plurality of pieces of the lubricant to a surface of the image transfer member;
a second brush roller configured to apply at least two of the plurality of pieces of the lubricant to a surface of the image drum member.
